(19) United States
(12) Patent Application Publication
(10) Pub. No.: US 2011/0291321 A1
(43) Pub. Date: Dec. 1, 2011

(54) ANATOMICALLY AND FUNCTIONALLY ACCURATE SOFT TISSUE PHANTOMS AND METHOD FOR GENERATING SAME

(75) Inventors: Raymond CHAN, BROOKLINE, MA (US); Robert MANZKE, CAMBRIDGE, MA (US); Douglas A. STANTON, OSSINING, NY (US); Guy SHECHTER, BRIARCLIFF MANOR, NY (US)

(73) Assignee: KONINKLIJKE PHILIPS ELECTRONICS N.V., EINDHOVEN (NL)

(21) Appl. No.: 13/207,861

(22) Filed: Aug. 11, 2011

Related U.S. Application Data
(62) Division of application No. 12/520,326, filed on Sep. 24, 2009.

(51) Int. Cl. B29C 39/10

(52) U.S. Cl. 264/222

(57) ABSTRACT

A method, system and apparatus for manufacturing anatomically and functionally accurate soft tissue phantoms with multimodality characteristics for imaging studies is disclosed. The organ/tissue phantom is constructed by filling a container containing an organ having inner vasculature therein with a molten elastomeric material; inserting a plurality of rods with bumps thereupon through the container and the organ; allowing the molten elastomeric material to harden and cure; removing the organ; replacing the organ with a plurality of elastomeric segments; and removing an elastomeric segment and replacing the void created thereupon with molten PVA to create a PVA segment; allowing the molten PVA segment to harden and cure; and repeating the creation of PVA segments until all the elastomeric segments have been removed, such that each successive molten PVA segment adheres to and fuses with the previous hardened PVA segment so as to form an approximately complete organ phantom cast. The organ/tissue phantom is completed by inserting the approximately complete organ phantom cast inserting upside-down into a fixture made from the bottom-most elastomeric segment, which contains molten PVA; and allowing the molten PVA to harden and cure.

### FIELD OF THE INVENTION

The present invention relates to medical organ phantoms and, more particularly, to a method, apparatus and system for creating and/or generating anatomically and functionally accurate soft tissue phantoms with multimodality characteristics for imaging studies.

### BACKGROUND OF THE INVENTION

Researchers working with CT, X-ray, MRI, PET/SPECT, ultrasound, optical imaging, electromagnetic imaging (e.g., RF, microwave, THz) and other imaging technologies require imaging targets. These targets are needed, inter alia, to test and validate imaging hardware and software performance. Imaging studies generally require use of anatomically-accurate and functionally-accurate organ phantoms. These “phantoms” allow for lengthy investigations for validation and testing of imaging equipment without the necessity of human patients or other living models, thereby avoiding unnecessary exposure to X-ray and other risks. Phantoms vary in complexity depending upon a various parameters, e.g., imaging requirements. In some situations, simple cylinders or other rudimentary structures may suffice, but in other situations, anatomically-accurate, functionally-accurate, dynamic, multi-modal imaging characteristics are required. Phantoms with high degrees of functionality can employ materials that closely approximate the mechanical and/or chemical properties of tissue while maintaining MRI, X-ray, CT, PET/SPECT, ultrasound imaging and other imaging qualities.

Anatomical accuracy for purposes of imaging targets has been difficult to achieve in practice due to the enormous complexity of organ geometry. Commercially-available phantoms generally offer rigid anatomical representations of the organ-of-interest, without dynamic tissue-mimicking biomechanical deformations/functionalities or imaging characteristics that allow for multimodality testing (e.g., MR, CT, X-ray, US, PET/SPECT).

What is needed, but has heretofore not been achieved, are phantoms that exhibit a range of properties that closely mimic the behaviour of biological tissue in terms of image appearance, mechanics and/or chemical characteristics. The present invention describes a novel phantom technology that addresses the shortcomings of conventional imaging targets, while allowing the creation/generation of high-functionality imaging targets. The imaging targets/phantoms that are created/generated according to the present invention offer a host of significant advantages, particularly in test environments, e.g., environments involving testing of multimodality hardware and software for reconstruction, segmentation, registration, quantification and/or visualization.

### SUMMARY OF THE INVENTION

The present invention provides advantageous methods, systems and apparatus for creating/generating an anatomically-correct tissue or organ phantom. Exemplary phantoms generated according to the present invention offer tissue-mimicking mechanical properties that are reproduced directly from an original structure, e.g., a human organ. According to exemplary embodiments, the phantom is constructed by filling a container containing an organ or other tissue structure of interest having inner vasculature with a molten elastomeric material; inserting a plurality of rods through the container and the organ/tissue; allowing the molten elastomeric material to harden and cure; removing the organ/tissue; replacing the organ/tissue with a plurality of elastomeric segments; removing an elastomeric segment; and replacing the void created thereupon with a molten material, e.g., polyvinyl alcohol (PVA), to create a PVA segment. The molten PVA segment is generally allowed to harden and cure, and the foregoing steps are repeated so as to create additional PVA segments until all elastomeric segments have been removed.

Each successive molten PVA segment generally adheres to and fuses with the previous hardened PVA segment so as to form a substantially complete organ/tissue phantom cast. In exemplary embodiments, organ/tissue phantoms may be formed by positioning the organ/tissue phantom cast in a fixture or other stabilizing structure, e.g., upside-down. A range of elastomeric materials may be used according to the present disclosure. In exemplary embodiments, the elastomeric material is silicone rubber.

Through the technique disclosed herein, highly accurate and useful organ/tissue phantoms may be created in an efficient and reliable manner. Most organs and anatomical/tissue structures may be effectively replicated for phantom purposes, such organ/tissue phantoms being characterized by properties that closely mimic the anatomical characteristics of the underlying organ/tissue. In a particularly preferred embodiment of the present disclosure, a phantom human heart may be created for use in imaging studies or the like.

Additional features, functions and benefits of the disclosed systems, methods and apparatus will be apparent from the detailed description which follows, particularly when read in conjunction with the appended figures.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a schematic diagram of a heart phantom produced using a prior art “Lost Wax” method;

FIG. 2 is an FD10 X-Ray image of a “doped” PVA phantom constructed according to the method of the present invention;

FIG. 3 is a 3D ultrasound image of a “doped” PVA phantom constructed according to the method of the present invention;

FIG. 4 is a schematic diagram of an exemplary heart phantom being constructed according to the method of the present invention, wherein a human heart is placed in a container which is then filled with silicone rubber;

FIG. 5 is a schematic diagram of an exemplary heart phantom being constructed according to the disclosed method, wherein a plurality of rods are thrust through one side of the mould container;

FIG. 6 is a schematic diagram of an exemplary heart phantom being constructed according to the disclosed method, wherein the heart has been removed and the blood volume moulds have lost registration relative to an outer mould;

FIG. 7 is a schematic diagram of an exemplary heart phantom being constructed according to the disclosed method, wherein the plurality of rods are reinserted into their previous locations through the mould container to restore registration;

FIG. 8A is a schematic diagram of an exemplary heart phantom being constructed according to the disclosed method, wherein the mould container is filled with one segment of silicone rubber;

FIG. 8B is a schematic diagram of an exemplary heart phantom being constructed according to the disclosed method, wherein the mould container is filled with a second segment of silicone rubber;

FIG. 8C is a schematic diagram of an exemplary heart phantom being constructed according to the disclosed method, wherein the mould container is filled with a third segment of silicone rubber;

FIG. 8D is a schematic diagram of an exemplary heart phantom being constructed according to the disclosed method, wherein the mould container is filled with a fourth segment of silicone rubber;

FIG. 9 is a schematic diagram of an exemplary heart phantom being constructed according to the disclosed method, wherein segments of silicone rubber are removed and replaced with molten PVA;

FIG. 10 is a schematic diagram of an exemplary heart phantom being constructed according to the disclosed method, wherein all silicone rubber segments have been removed and replaced with molten and solid PVA (newly added molten PVA fuses with previously added/solid PVA);

FIG. 11 is a photograph of a top view of an exemplary PVA heart cast which is removed from the registered mould with the hard plastic moulds in registration;

FIG. 12A is a photograph of a front side view of the exemplary PVA heart cast of FIG. 11 with the hard plastic moulds removed;

FIG. 12B is a photograph of a top view of the exemplary PVA heart cast of FIG. 11 with the hard plastic moulds removed;

FIG. 13 is a schematic diagram showing completion of a PVA heart cast while it is maintained in a mounting fixture;

FIG. 14 is a photograph of a perspective view of an exemplary mounting fixture;

FIG. 15A is a photograph of a perspective view of a completed PVA heart cast in the mounting fixture of FIG. 14;

FIG. 15B is a photograph of a side view of a completed PVA heart cast in the mounting fixture of FIG. 14;

FIG. 16 is a schematic view of a completed phantom heart attached to the mounting arrangement for permitting robust mechanical manipulation by servo motors under the control of an external controller;

FIG. 17 is a photograph of an exemplary test setup shown schematically in FIG. 16, in which the mechanical manipulation of the heart phantom is synchronized to an ECG waveform on the display of a laptop computer;

FIG. 18 is a photograph of the test setup shown in FIG. 17 with the addition of ultrasound, X-Ray, and Aurora imaging equipment; and

FIG. 19 is a photograph of an exemplary test setup used for calibration of the 3D space surrounding a heart phantom for use in the mechanical manipulation test fixtures of FIGS. 16-18.

### DETAILED DESCRIPTION OF THE INVENTION

The methods, systems and apparatus of the present invention provide anatomically-correct organ/tissue phantoms with tissue-mimicking mechanical properties. The disclosed phantoms are advantageously reproduced directly from an original organ/tissue, e.g., a human heart. Although the present invention is described in terms of producing an anatomically accurate heart phantom, the present invention can be used to produce phantoms of other internal organs, tissues and anatomical structures, both animal and human.

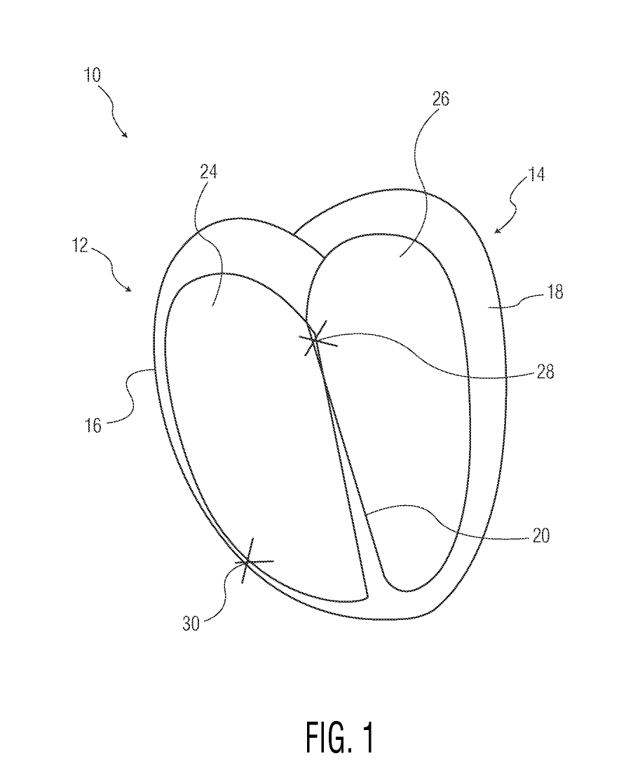

With reference to FIG. 1, a schematic diagram of a heart phantom produced using the prior art “Lost Wax” method is shown, generally indicated at 10. The positive replica 10 includes a left segment 12 and a right segment 14 which define heart walls 16, 18 and a central septum 20. The segments 12, 14 and the septum 20 are formed from a negative external mould 22 and internal blood volume casts 24, 26. Although the internal casts 24, 26 and the external mould 22 are easily made, using these to directly cast a positive replica proves problematic in that the inner casts 24, 26 are no longer registered to the external mould 22. This registration needs to be accurate at the sub-millimeter level in three dimensions due to the large thickness variation in the heart walls 16, 18 and the septum 20. Without a high degree of accuracy, holes can form at locations 28 in the septum 20 or in the external heart walls 30.

Another problem to overcome is entrapment of the internal casts 24, 26. Since the positive replica 10 is a shape with internal voids and relatively small outlets to the outside world (not shown), internal blood volume casts 24, 26 (the blood volume) would be trapped inside the replica 10 and would need to be removed. Ancient techniques (lost wax) would serve well here. The blood volume casts 24, 26 could be poured out when heated. Unfortunately, the material used for the blood volume casts 24, 26 would have to melt +/−100° F. to prevent damage to a suitable material for the heart walls 16, 18. The methods, systems and apparatus of the present invention overcome the significant limitations of melt-based techniques through an advantageous segmentation approach.

A preferable casting material for use as the final phantom cast is polyvinyl alcohol (PVA). PVA is a cryogel which has remarkable tissue-like properties, and by manipulation of temperature, time, and composition, physical properties of organs may be approximated PVA produces phantoms of high anatomical accuracy and texture, while making it possible to attain accurate registration and eliminate entrapment. This material is described in the following references, which are incorporated herein by reference in their entirety: Kenneth C. Chu and Brian K. Rutt, “Polyvinyl Alcohol Cryogel: an Ideal Phantom Material for MR Studies of Arterial Flow and Elasticity,” Departments of Medical Biophysics and Diagnostic Radiology, University of Western Ontario, and Tom Lawson Family Imaging Research Laboratories, John P. Robarts Research Institute, London, Ontario, Canada; R. C. Chan, M. Ferencik, T. Wu, U. Hoffmann, T. J. Brady, and S. Achenbach, “Evaluation of arterial wall imaging with 16-slice multi-detector computed tomography”, Computers in Cardiology 2003, Thessaloniki, Greece, September, Vol. 30:661-4, 2003; A. Chau, R. Chan, S. Nadkarni, N. Iftimia, G. J. Tearney, and B. E. Bouma, “Vascular optical coherence elastography: assessment of conventional velocimetry applied to OCT”, in Biomedical Topical Meetings on CD-ROM (The Optical Society of America Biomedical, Washington, D.C., 2004), FH47; and M. Ferencik, R. C. Chan, S. Achenbach, J. B. Lisauskas, S. L. Houser, U. Hoffmann, S. Abbara, R. C. Cury, B. E. Bouma, G. J. Tearney, and T. J. Brady, “Evaluation of Arterial Wall Imaging with 16-slice Multi-detector Computed Tomography in Vessel Phantoms and Ex Vivo Coronary Arteries,” Radiology 2006 (in press).

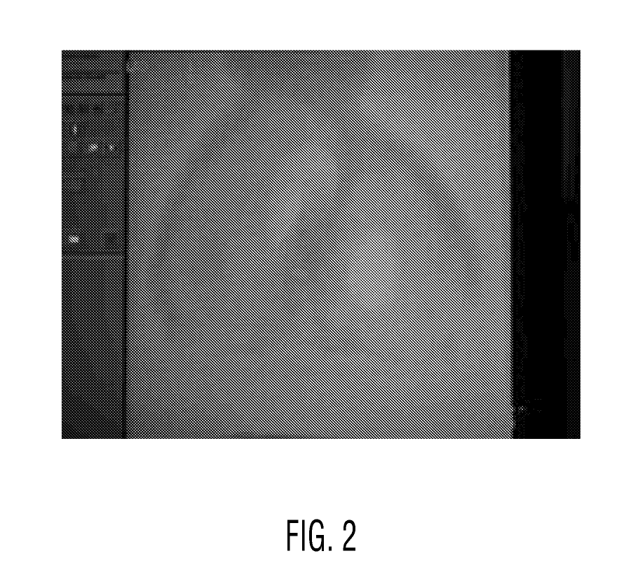

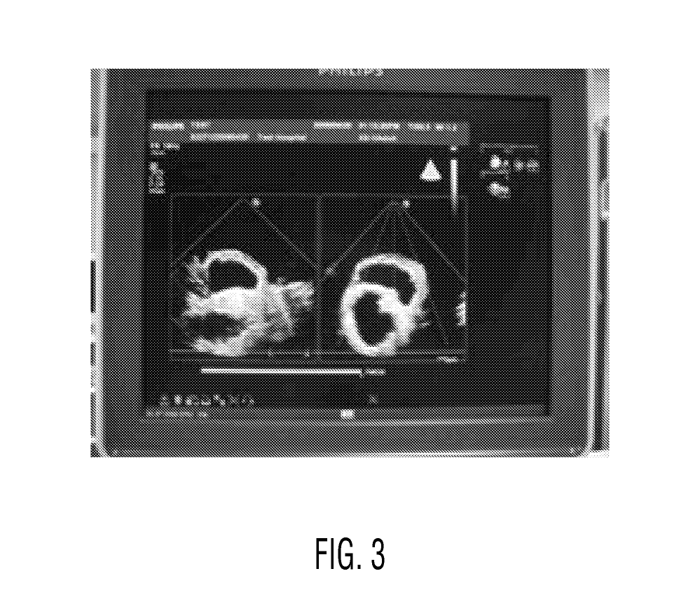

PVA in its natural state is virtually transparent to X-Ray and Ultrasound (depending on frequency used). PVA can be doped, i.e., materials like iodine, graphite, MR contrast (e.g., gadolium, copper sulphate and the like), MR iron-oxide nanoparticles, and/or optical contrast agents (e.g., microspheres, optical nanoshells, intralipid, lipids/oils, optical dyes, ultrasonic microbubbles) can be added to achieve required imaging densities. Representative images of doped PVA phantoms are shown in FIG. 2 using an FD10 X-Ray and in FIG. 3 using 3D ultrasound.

PVA has the additional advantageous property that it can be poured onto a previously cast and cured PVA segment and heated to create a bonded single piece composite cast with no signs of demarcation between segments. As a result, an organ/tissue phantom, e.g., a heart phantom, can be built of a number of slices or segments fused together to yield registered and un-entrapped interior detail. In an exemplary method, system and apparatus of the present invention, registration is achieved by successively casting a plurality of silicone rubber segments vertically, one atop the other, until a nearly complete heart shaped cast is created. These segments are cast such that they do not bond together and are securely registered on both the surface of the blood volume and the inside of the surface cast of the heart exterior. Such method, system and apparatus of the present invention produces blood volume positive casts that are tightly registered to the inside of the external surface of a negative heart (or other organ/tissue/anatomical) mould.

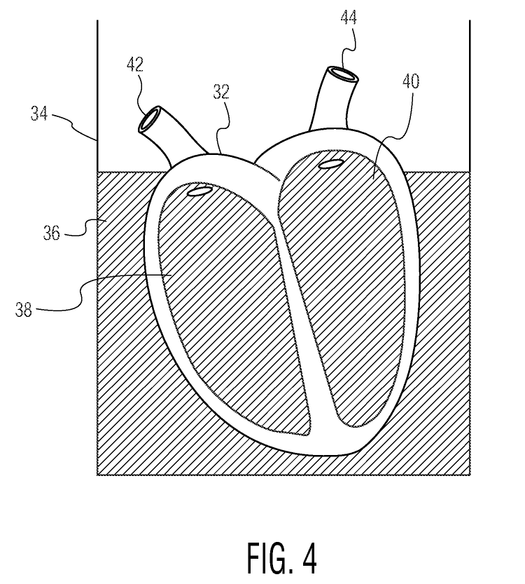

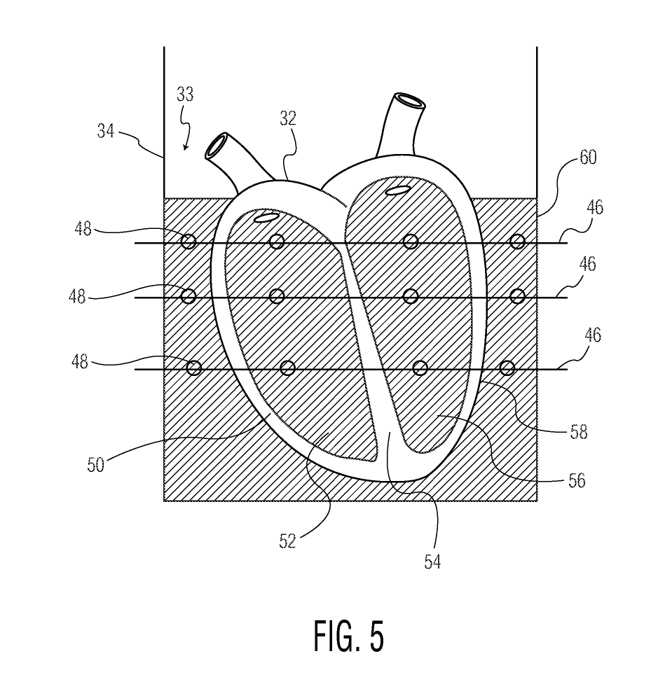

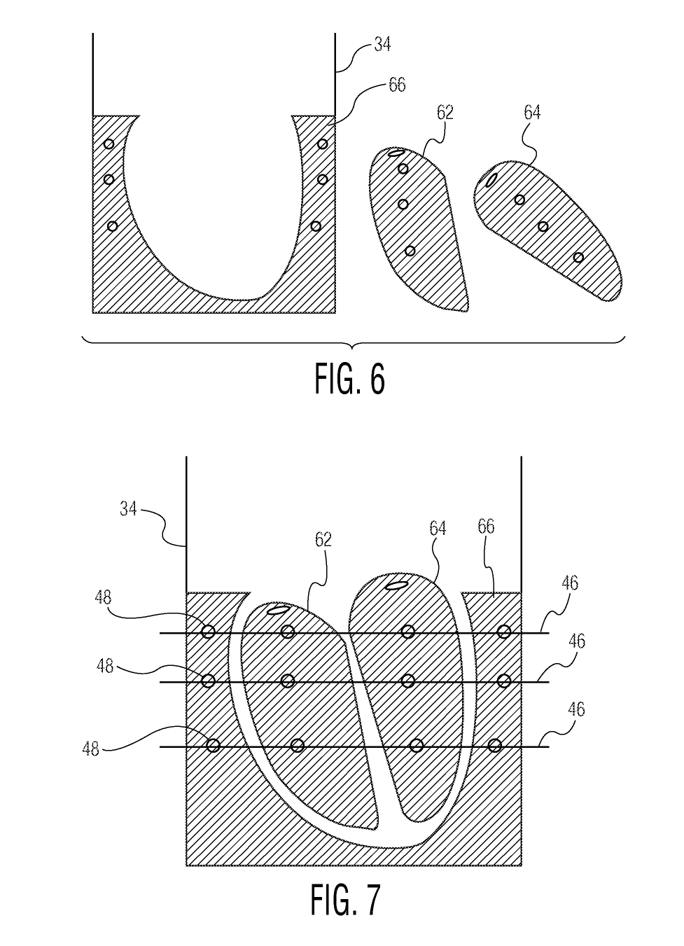

FIGS. 4-10 and 13 illustrate steps that may be employed according to the present disclosure to create/manufacture a PVA heart phantom. In FIG. 4, a human heart 32 is placed in a container 34 filled partially with silicone rubber 36. Then, the ventricles 38, 40 are filled with silicone rubber through the vessel openings 42, 44. In FIG. 5, a plurality of rods 46 having a number of (spherical) “bumps” 48 are thrust through one side 33 of the mould container 34, piercing in succession a heart wall 50, an inner blood volume 52, the septum 54, a second blood volume 56, the remaining heart wall 58, and the remaining container wall 60. The silicone rubber is then allowed to cure, which creates blood volume moulds 62, 64 and an outer mould 66 (see FIG. 6). The heart 32 is then removed from the mould container 34 and dissected to free the internal blood volume (moulds) 62, 64. As shown in FIG. 6, the blood volume moulds 62, 64 have lost registration to the outer mould 66. Referring now to FIG. 7, registration can be restored by reinserting a plurality of rods 46 with a number of “bumps” 48 in their previous locations through the mould container 34 and the blood volume moulds 62, 64, as shown.

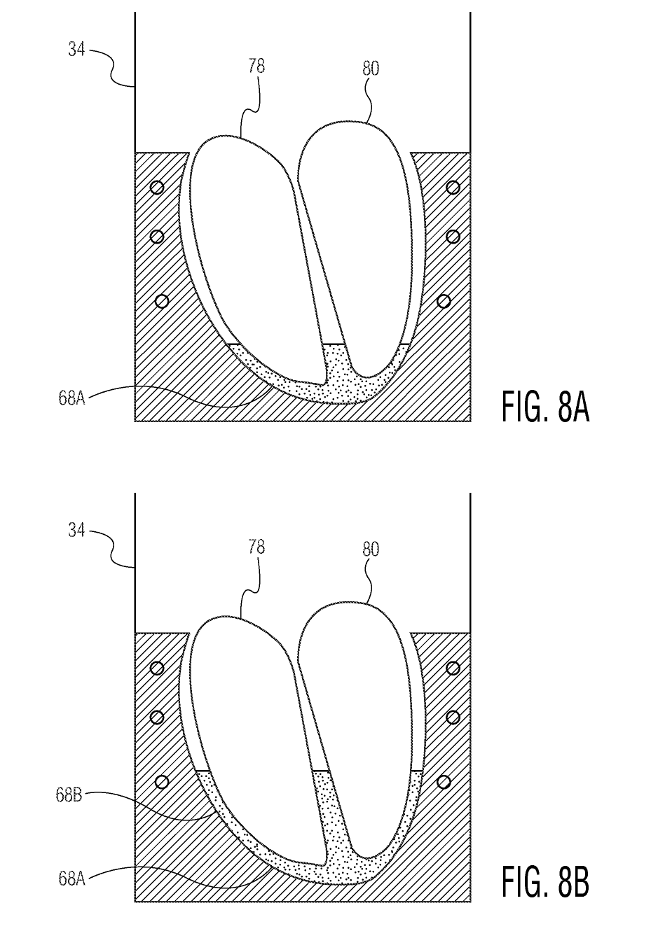

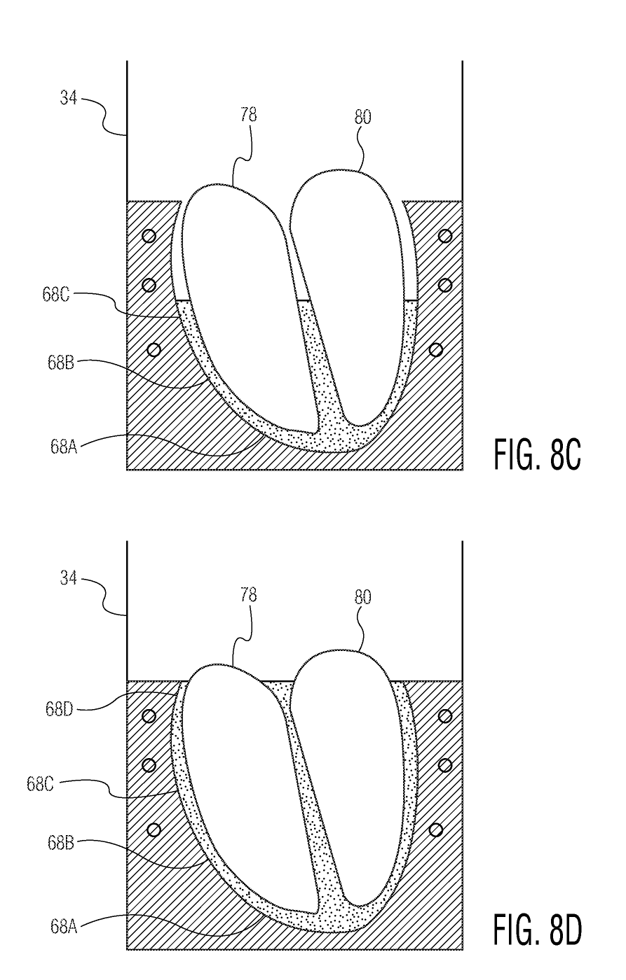

Referring now to FIGS. 8A-8D, the mould container 34 (which includes a plurality of inserted rods 46) is then filled with successive segments 68A-68D of molten silicone rubber. Each of the segments 68A-68D are allowed to solidify and cure. As a result, the segment 68B does not adhere to the segments 68A or 68C. Likewise, the segment 68C does not adhere to the segments 68B or 68D, etc. None of the segments 68A-68D bond to outer mould 66. The blood volume moulds 62, 64 are removed and negative moulds are made of them. From the negative moulds, positive hard plastic blood volume moulds 78, 80 are made.

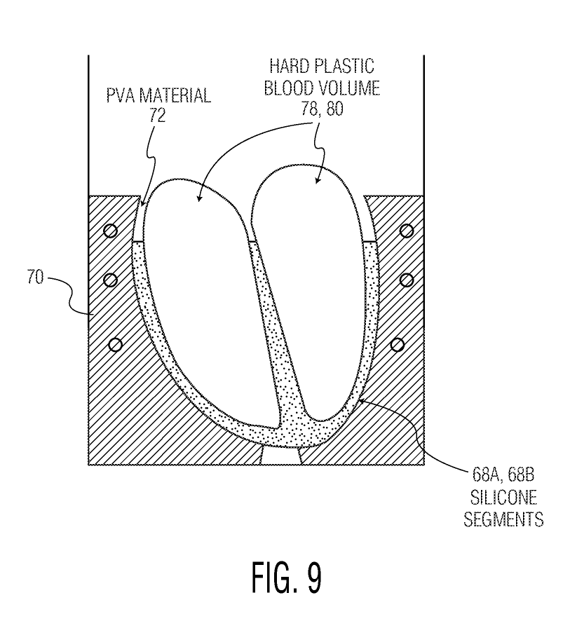

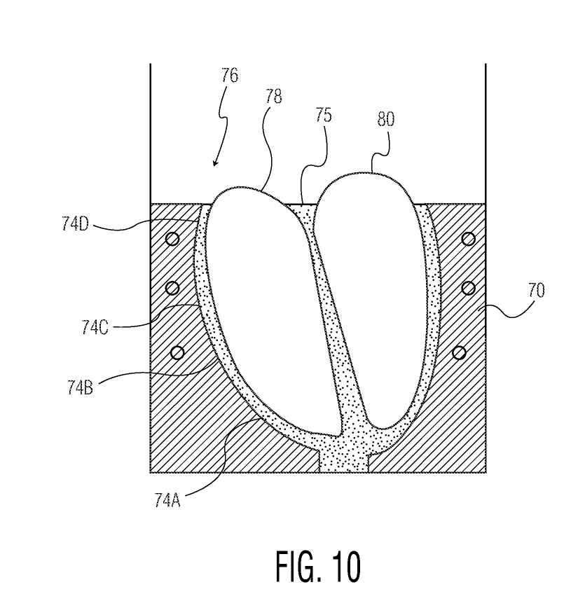

Referring now to FIG. 8D, the hard plastic moulds 78, 80 are placed inside the segments 68A-68D that were cast earlier. The segments 68A-68D determine the rigidity and quality of registration. Referring to FIGS. 9 and 10, the PVA material 72 is cast in the registered mould. The plurality of rods 46 are all removed. Then, the silicone segments 68A-68D are removed one at a time and the voids are filled with PVA to produce PVA segments 74A-74D. The newly added PVA segments 74A-74D fuse with the previously added/cured PVA segments, e.g., under appropriate temperature conditions. Typically, the fusion process is undertaken sequentially, i.e., adjacent PVA segments are fused one at a time. When all the PVA segments 74A-74D have hardened and cured, there results a nearly complete PVA heart cast 76.

Thus, in an exemplary technique for fabricating a phantom according to the present disclosure, e.g., a heart phantom, the following steps are employed:
A mould of the outside of the heart is formed, as described above.
A silicone replica of the heart is formed using the foregoing mould.
The silicone segment of the heart apex replica is placed in the bottom of the foregoing negative outer silicone mould of the heart.
Rigid implants/hard plastic moulds (e.g., elements 78, 80) are inserted into the heart apex replica that is positioned at the bottom of the heart mould.
PVA (or other suitable polymeric material) is poured around the plastic moulds and treated/cured to a hard condition.
Remove from mould and separate silicone apex replica from hard plastic moulds/PVA combination. Return the hard plastic moulds/PVA combination to the mould and turn “upside-down”.
Add PVA through opening in bottom of mould; newly added PVA bonds or fuses to the previously hardened PVA (under appropriate temperature conditions), thereby replicating the previously-removed apex.
The structure is removed from the mould and the hard plastic moulds are removed from within the PVA.

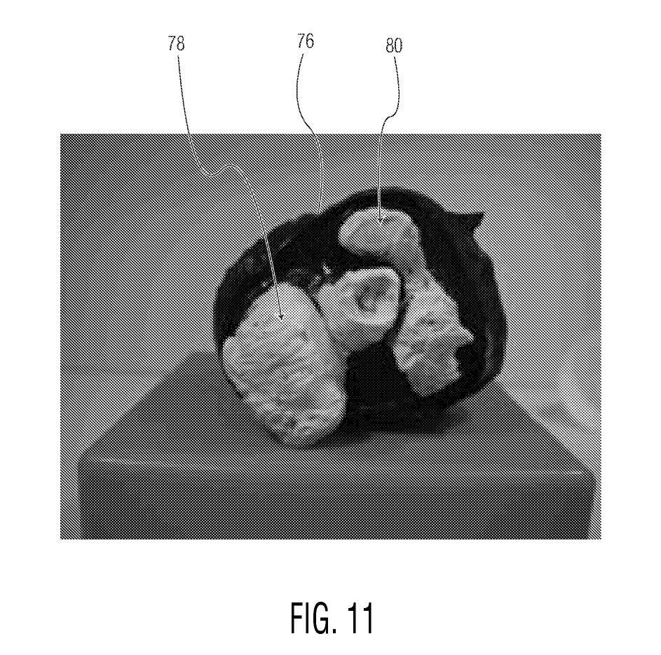

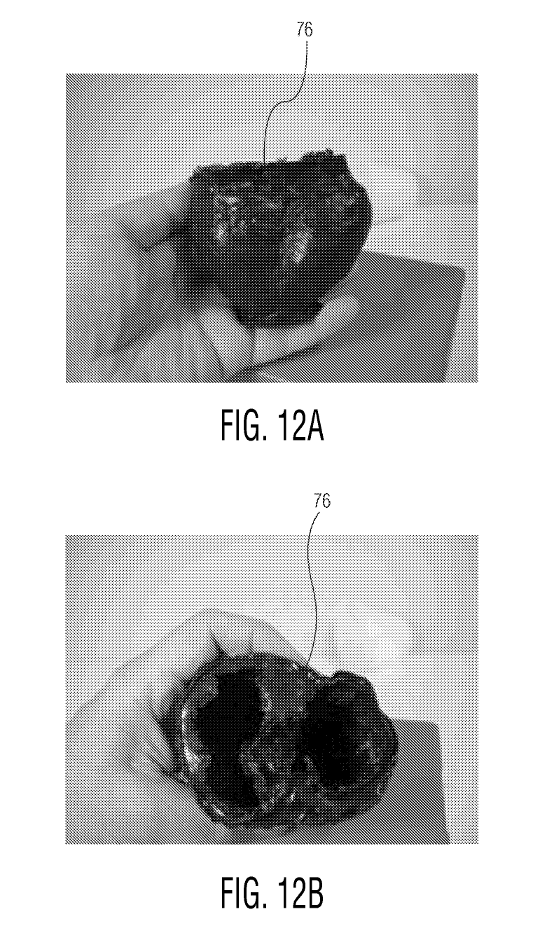

FIG. 11 shows a photograph of the PVA heart cast 76 removed from the outer mould 70 but with the hard plastic moulds 78, 80 in registration, while FIGS. 12A-12B are photographs showing the PVA heart cast 76 with the hard plastic moulds 78, 80 removed. Removal of hard plastic moulds 78, 80 may be assisted/facilitated by water lubrication.

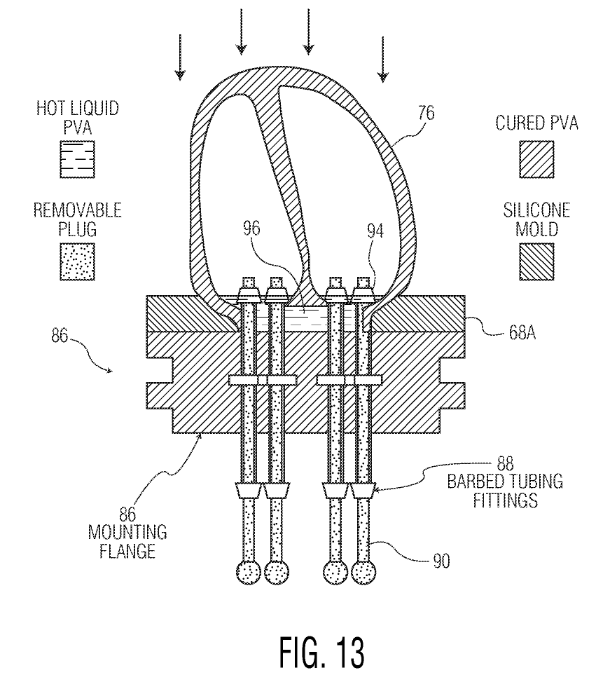

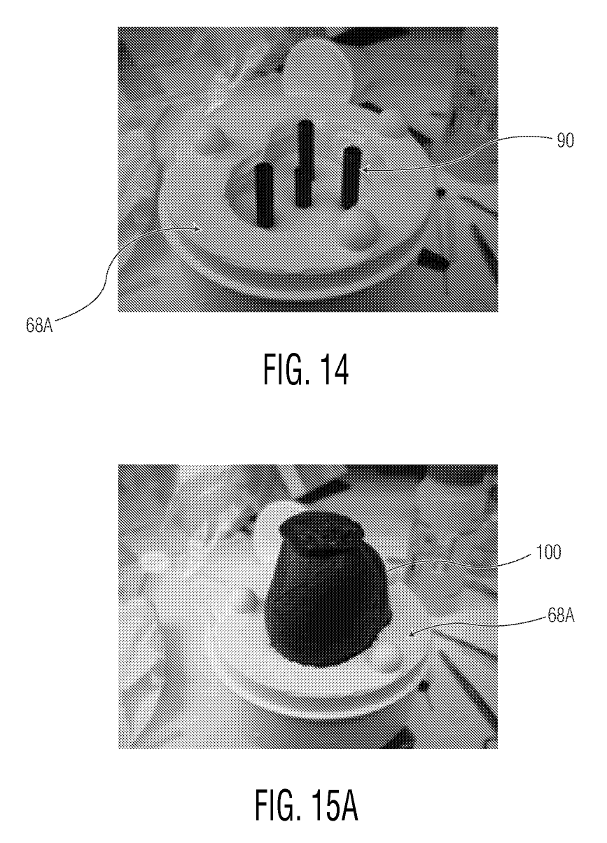

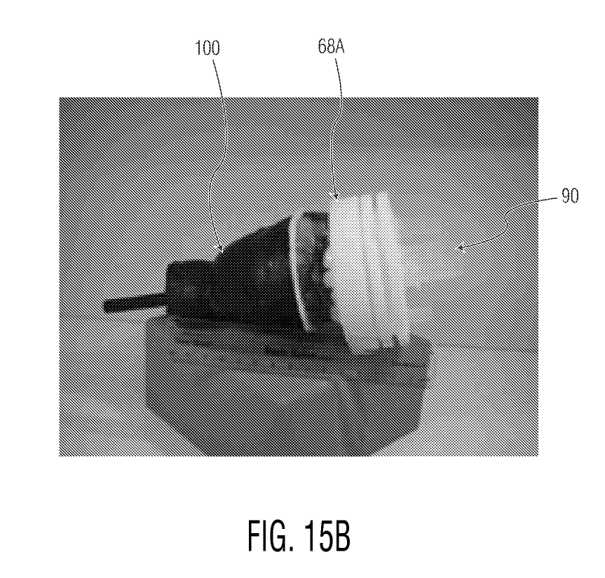

Referring now to FIGS. 13 and 14, the PVA heart cast 76 is typically completed by employing a mounting arrangement 84, which includes the silicone mould segment 68A, a cured PVA flange 86, a plurality of barbed tube fittings 88, and a plurality of tubes 90. The silicone mould segment 68A is turned upside-down and mounted to the cured PVA flange 86 via the plurality of barbed tube fittings 88 therebetween. The plurality of tubes 90 are then inserted at one end 92 of the barbed tube fittings 88 until the plurality of tubes 90 protrude a predetermined distance from the other end 94 of the barbed tube fittings 88. A pool of hot PVA 96 of appropriate depth is poured to a level flush with the top 98 of the silicone mould segment 68A. The hot PVA 96 immediately blends with underlying cured PVA flange 86. The PVA heart cast 76 is then reinserted into the silicone mould segment 68A of the mounting arrangement 84 containing the hot PVA 96. The hot PVA 96 is displaced up into the PVA heart cast 76 forming an overlapping fusion bond. When this composite is cooled and heated to cure the PVA, a completed phantom heart 100 is formed (see FIGS. 15A and 15B).

Thus, from a step-wise standpoint, this second fabrication stage generally involves the following steps:
Utilizing a second mould of the outside of the heart, a set of fittings are positioned with respect to such second mould and face downwardly. This mould is of limited height (e.g., approximately one inch).
PVA is poured atop the second mould to form a PVA pool within a dam-like structure. The fittings extend above the PVA pool.
The heart mould fabricated in the first series of steps is turned upside down and pressed downward into the PVA pool until it registers with the mould details, thereby defining a complete heart phantom. As before, the newly added PVA bonds or fuses to the previously hardened PVA (under appropriate temperature conditions).

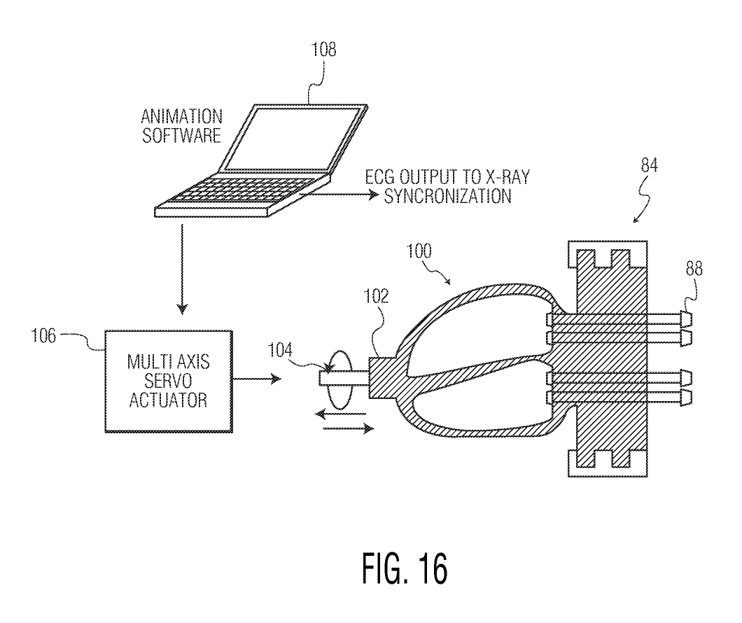

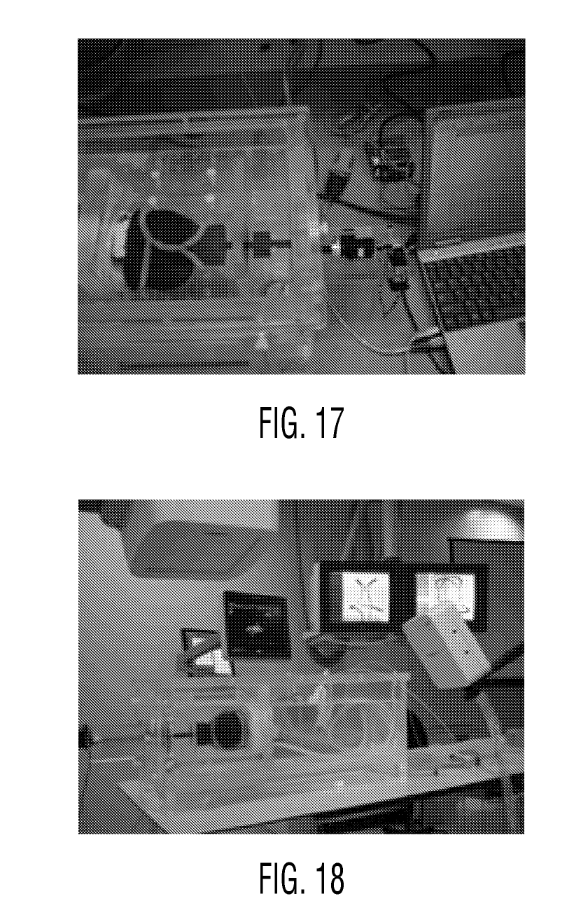

Referring now to FIG. 16, the completed phantom heart 100 is shown attached to the mounting arrangement 84 for permitting robust mechanical manipulation. The apex 102 of the phantom heart 100 can be fitted with a coupling 104 which is actuated by servo motors 106 or other actuating units under the control of an external controller 108, such as a personal computer. The coupling 104 permits compression and rotation of the completed phantom heart 100 using servo motors 106. A blood surrogate (not shown) may be pumped by external means or, with the addition of appropriate valves, pumped by the completed phantom heart 100. Software loaded into the controller 108 is generally employed to control required heart movements via the servo motors 106. This software has the capability, for example, to source ECG signals in synchronization with the servo motors 106. FIG. 17 shows a photograph of the completed phantom heart 100 in the mounting arrangement 84 which is driven by a two axis servo motor 110 under software control, outputting a synchronized ECG waveform on the display 112 of a laptop computer 114. FIG. 18 is a photograph of the same arrangement complete with ultrasound, X-Ray, and Aurora imaging equipment.

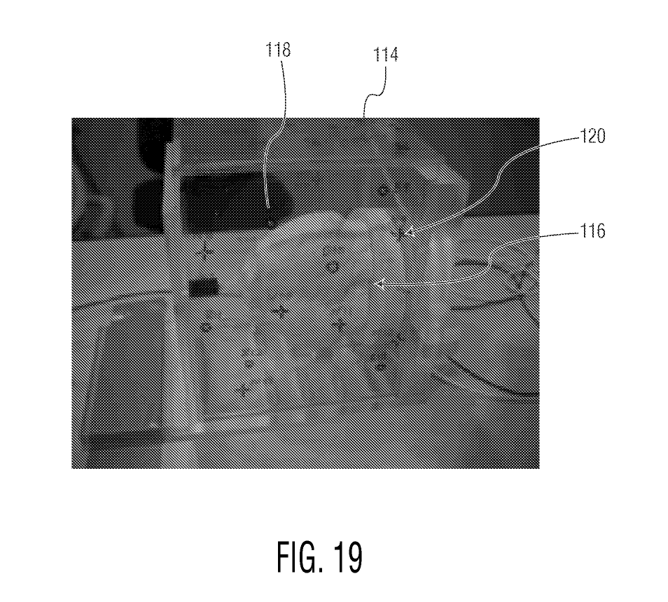

Referring now to FIG. 19, exemplary calibration of the 3D space surrounding a heart phantom is provided by inserting a “U” shaped fixture 114 into a keyway 116 in the mounting arrangement 84. The fixture 114 contains numbers of stainless steel balls 118 fixed at random locations about the fixture 114. The positions of the balls 118 are precisely determined with respect to reference marks 120 in the three planes of the fixture 114. Referring again to FIGS. 18 and 19, the 3D space encompassing the completed phantom heart 100 will be “seen” by X-ray, ultrasound, and an Aurora magnetic probe (not shown). While X-ray imaging and an ultrasound probe can satisfactorily resolve the steel balls to define the volume, the image “seen” by the Aurora magnetic probe is distorted by the presence of the steel balls when the probe is placed on them during calibration. To combat this deficiency, additional shallow holes may be drilled adjacent to the steel balls at precisely known offsets. The magnetic probe is placed in these surrogate locations, the offsets are noted in software, and the 3D volume is acquired.

The present invention is subject to numerous applications. The tissue-mimicking polyvinyl-alcohol material used to construct the completed heart phantom 100 can be “biologically-functionalized” by replacing some or all of the PVA with a tissue-engineering extra-cellular matrix seeded with living cells or chemically-active molecular markers/probes. This approach allows for even closer approximation of the biochemical properties of living tissue, in particular with respect to metabolic processes that are essential to functional imaging techniques such as with PET or SPECT. In addition, fiducial targets such as beads, rubies, contrast-containing PVA-microspheres, capsules, microbubbles, etc., can be embedded in either a targeted or randomized fashion within the phantom tissue to provide additional markers to be used for validation experiments. In another exemplary embodiment, 3D printing techniques can be combined with phantom generation in such a way as to allow the use of patient-specific imaging volumes from which segmented organ surfaces can be extracted. These surfaces can then be fed directly to a 3D printer for construction of a negative mould into which a PVA “tissue” matrix can be poured and formed. Alternately, a novel 3D printing technology could be developed which allows for direct PVA printing in 3D. In this approach, PVA droplets are layered in a manner akin to current inkjet technology in low-cost consumer printers.

The present invention has several advantages over prior art phantoms and phantom generating techniques. For example, the methods, systems and apparatus of the present invention provide anatomically-accurate and functionally-accurate organ/tissue phantoms which can be used in any experiment intended for testing and validation of multimodality imaging hardware and software platforms. Clinical applications include, but are not limited to, testing of strategies for interventional procedure guidance (e.g., thyroid biopsy, liver biopsy ablation, prostate biopsy/ablation, etc.), cardiac catheterization, electrophysiology procedures, and minimally-invasive surgery. The disclosed methods, systems and apparatus allow for the injection of adjustable multimodality tissue-mimicking contrast for natural or enhanced imaging by X-ray, ultrasound, MRI (this is extensible to nuclear medicine imaging techniques such as PET/SPECT with the introduction of radiotracers within the “tissue” matrix), and other optical and/or electromagnetic imaging modalities (e.g., RF, microwave and THz). Moreover, the present invention provides an adjustable approximation of the physicochemical properties of heart tissue. In addition, the present invention provides for:
dynamic and programmable heart motion, including but not limited to, torsion/rotation and compression;
attached or imbedded vasculature;
accurate internal and external anatomical details including wall thickness;
ECG (or any arbitrary waveform) output for synchronization to CT, cardiac X-ray and other medical equipment;
tubing fittings incorporated into heart structure;
mechanical mounting appropriate for mechanical operation; and
integrated calibration feature to define the 3D volume of the heart.
   The present invention can also be housed in a configurable water filled tank with a large ultrasound access port and a dynamic mechanical access port for testing of interventions typical of electrophysiology or cardiac catheterization procedures.

It will be understood that the embodiments described herein are merely exemplary and that a person skilled in the art may make many variations and modifications without departing from the spirit and scope of the invention. All such variations and modifications are intended to be included within the scope of the invention.

1. A method for generating an organ or tissue phantom, comprising the steps of:
(a) positioning an organ or tissue in a container with a molten elastomeric material;
(b) inserting a plurality of rods through the container and the organ or tissue;
(c) allowing the molten elastomeric material to harden and cure;
(d) removing the organ or tissue from the container;
(e) replacing the removed organ or tissue with a plurality of elastomeric segments;
(f) removing a first elastomeric segment and replacing the void created thereupon with molten polyvinyl alcohol (PVA) to create a PVA segment;
(g) allowing the molten PVA segment to harden and cure; and
(h) repeating steps (f) and (g) for successive segments until all elastomeric segments of the plurality of elastomeric segments have been removed,
wherein each successive molten PVA segment adheres to and/or fuses with the previous hardened PVA segment so as to form a substantially complete organ or tissue phantom cast.

2. The method of claim 1, wherein the organ or tissue includes inner vasculature.

3. The method of claim 1, further including the step of inserting the organ or tissue phantom cast into a fixture made from a bottom-most elastomeric segment, said bottom-most elastomeric segment containing molten PVA; and allowing the molten PVA to harden and cure so as to form a complete organ or tissue phantom.

4. The method of claim 2, further comprising the steps of:
(i) removing elastomeric moulds formed in the inner vasculature after step (e);
(j) forming negative moulds from said removed elastomeric moulds; and
(k) forming positive hardened plastic moulds from the negative moulds.

5. (canceled)

6. The method of claim 4, further including the step of:
(l) reinserting the hardened plastic moulds into the plurality of elastomeric segments and then into the container to form a registered mould before step (f).

7. The method of claim 2, wherein step (c) produces inner vasticular elastomeric moulds and an outer elastomeric mould, and wherein removing the organ or tissue of step (d) further causes the inner vasticular elastomeric moulds to have lost a registration to the outer elastomeric mould, the method further comprising:
(m) reinserting the plurality of rods in previous locations through said container, said outer elastomeric mould and said inner elastomeric moulds to restore the registration, wherein step (e) further includes the steps of:
(n) filing a void, created by (i) the outer elastomeric mould, (ii) the inner vasticular elastomeric moulds, and (iii) the plurality of rods inserted into the outer elastomeric mould and the inner vasticular elastomeric moulds, with molten elastomeric material so as to cover at least the lowermost rod;
(o) allowing the molten elastomeric material to harden and cure; and
(p) repeating steps (n)-(o) successively until all of the inserted rods are covered so as to form the plurality of elastomeric segments, wherein each elastomeric segment does not adhere to an adjacent elastomeric segment.

8. The method of claim 1, wherein the organ or tissue phantom is a heart phantom.

9. (canceled)

10. The method of claim 1, wherein each of the plurality of rods include registration bumps.

11. (canceled)

12. The method of claim 10, wherein the bumps of each of the plurality of rods intersect the elastomeric mould material of at least two sides of the container and any intervening elastomeric moulds.

13. (canceled)

14. The method of claim 1, wherein the PVA is doped.

15. (canceled)

16. The method of claim 1, wherein some or all of the PVA is replaced with a tissue-engineering extra-cellular matrix seeded with living cells or chemically-active molecular markers/probes.

17-28. (canceled)
